(19) United States
(12) Patent Application Publication
(10) Pub. No.: US 2012/0250106 A1
(43) Pub. Date: Oct. 4, 2012

(54) METHOD, DEVICE AND SYSTEM FOR UPDATING AN APPLICATION ON A MOBILE DEVICE

(75) Inventors: Subbakrishna Ramsesh Kiran Kannambadi, Bangalore (IN); Nazia Merchant, Mumbai (IN)

(73) Assignee: Infosys Technologies Ltd., Bangalore (IN)

(21) Appl. No.: 13/076,133

(22) Filed: Mar. 30, 2011

(51) Int. Cl. H04N 1/04

(52) U.S. Cl. 358/474

(57) ABSTRACT

The instant disclosure is related to updating an application on a mobile device without using mobile network bandwidth. The mobile device initiates the application to be updated on the mobile device to scan an encoded image of a predetermined pattern from a source. It is followed by decoding of the scanned image to extract information required to update the application. And then, updating the application on the mobile device based on the extracted information.

### FIELD

The instant disclosure is generally related to upgrading of applications on mobile devices. More particularly, the disclosure describes upgrading of the applications on the mobile devices without using mobile network bandwidth.

### BACKGROUND

Presently, mobile applications are rendered and controlled using configuration file. In case of any updating/addition of features/modification of user data on the mobile application, the application has to be developed once again by backend systems. These newly developed applications with the updates are then pushed in to the user's mobile device. This is done using Wireless Application Protocol (WAP), General Packet Radio Service (GPRS), Bluetooth, Unstructured Supplementary Service Data (USSD) or Short Message Service (SMS) push.

To update an application on the mobile device, the application needs to be completely rebuilt and downloaded again on to the mobile device. To push new application updates to customer's device, a communication medium like WAP/GPRS, SMS, USSD or Bluetooth is used. This process of pushing the upgrades through these communication medium may not be completely real time and may lead to some processing delay. Also, it is not a cost effective method of doing the updating as it requires a complete infrastructure set up. Further, this method of updating uses valuable bandwidth of the communication medium.

In light of the foregoing discussion, there is a need to solve the above mentioned problems.

### SUMMARY

The shortcomings of the prior art are overcome and additional advantages are provided through the provision of a method, device and a system as described in the description.

One embodiment is a method for updating an application on a mobile device. The method comprising acts of initiating the application to be updated on a mobile device. Using the mobile device for scanning an encoded image from a source wherein the image is of a predetermined pattern. Decoding the scanned image for extracting information required to update the application. And updating the application on the mobile device based on the extracted information.

In one embodiment, the information is encrypted and the encrypted information is decrypted after decoding the scanned image.

In one embodiment, the present disclosure provides a mobile device comprising a camera capable of scanning an encoded image. The image comprises information required to update an application on the device. A processing unit capable of performing acts of initiating the application on the device, decoding the scanned image to extract the information, and updating the application on the mobile device based on the extracted information.

In one embodiment, the present disclosure provides a system for updating an application on a mobile device. The system comprising a server to generate an image of predetermined pattern. The image is encoded with information required to update the application. The system also has a mobile device to scan the generated image and to decode the information from the scanned image. The decoded information is then used to update the application.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings wherein like reference numerals represent like elements and in which:

FIG. 1 is a flow chart illustrating a method of updating an application by scanning an image.

FIG. 2 is a block diagram illustrating a mobile device updating an application by scanning an image using its camera.

FIG. 3 is a block diagram illustrating a server producing an image with an update information encoded in it for the mobile device updating.

The drawings depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Instant disclosure provides a method of updating an application on a mobile device. The method provides a solution by which the update information is embedded in to an image. The image is later scanned to retrieve that information. The retrieved information is then used to update the application on the device.

In one embodiment, the mobile applications are updated by changing the configuration file of the application. The content of the configuration file of the application is encoded in an image. Here, the image for example is a bar code image. Now, a mobile user runs the application on the mobile device for which the updates are available. The application then scans the image i.e. the bar code image and thereafter, decodes the configuration file information from that image. The application then updates its configuration file with the decoded information. It is clear that, this method of updating the application on the mobile device does not make use of any communication bandwidth. Thus, this method is a cost effective way of updating the mobile applications.

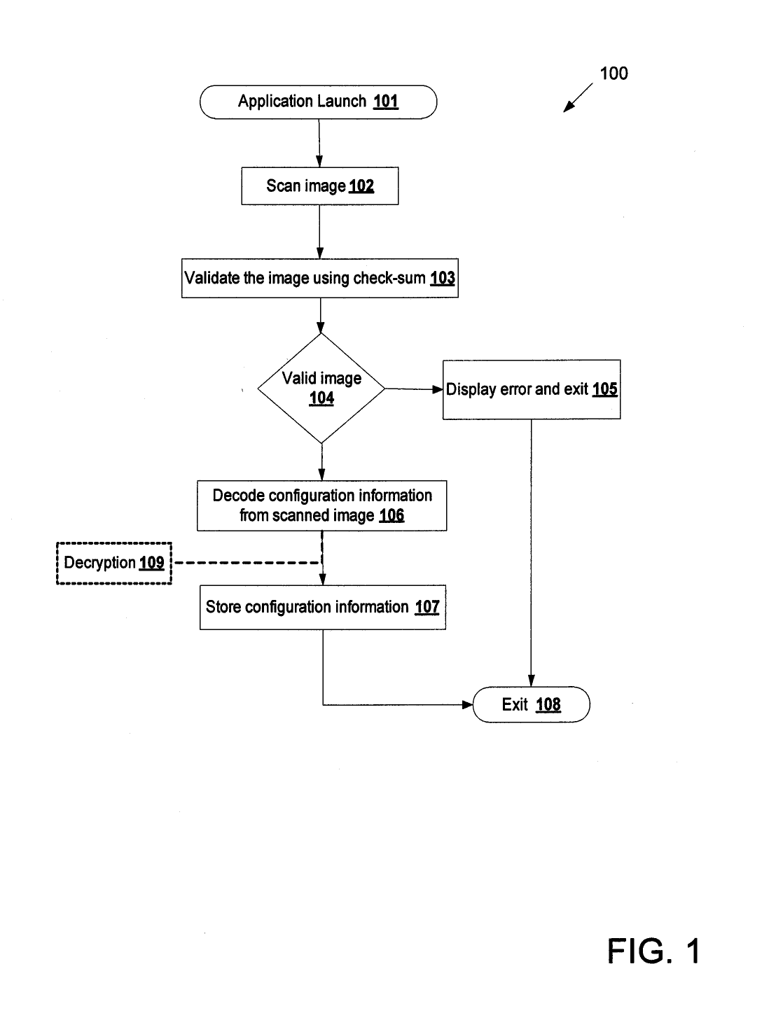

FIG. 1 shows a flow chart 100 describing the method of updating an application on the mobile device. At 101 the application which needs to be updated is launched on the device. An image is scanned by the application in 102. The image, as an example, is a bar code image. However the image can be a Quick Response (QR) code image or any image capable of carrying information which can be decode after scanning the image. The scanned image is then validated by using check-sum at 103. If a valid check sum is found, then the configuration file information is decoded from the image at 106. The decode information is then used to configure the application at 107. This is carried out by updating the configuration file of the application using the decoded information. After updating the configuration file, the application will exit from the process of updating. If valid check-sum is not found during validation, the application will exit from the process of updating by displaying an error message 105 without updating the configuration file.

In one embodiment, the configuration file information in the image is encrypted. Once the information is decoded from the image at 106 after scanning, the encrypted information is decrypted at 109. The decrypted information is then used to configure the application at 107.

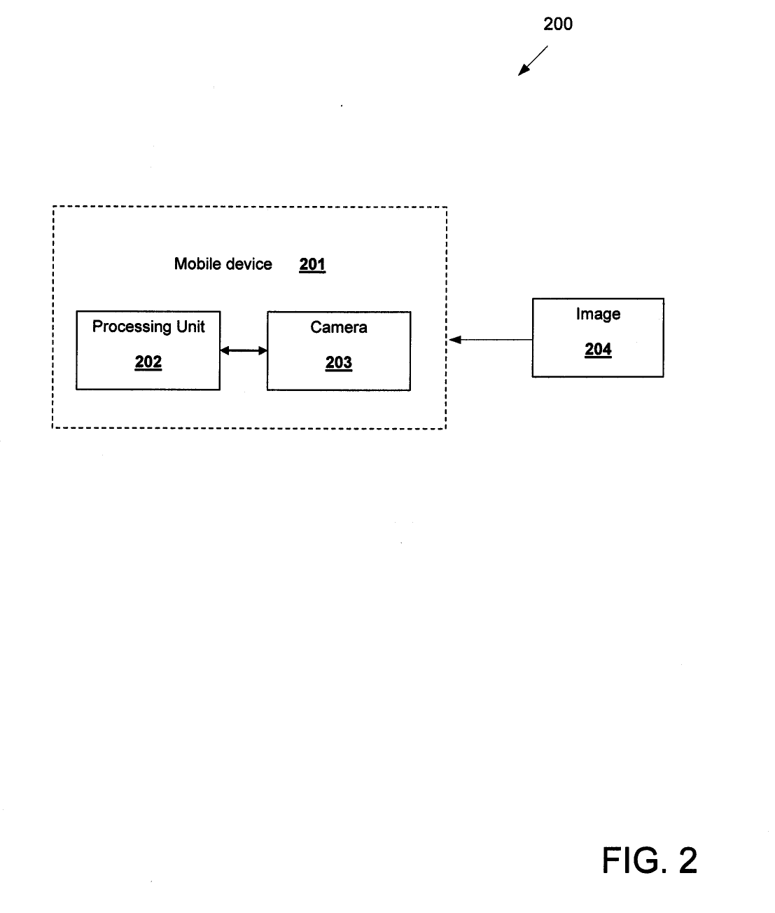

FIG. 2 shows a mobile device 201 having processing unit 202 and camera 203. An image 204 carries encoded configuration file information that is required to update an application on the mobile device 201. A camera 203 on the mobile device is used to scan the encoded image. The processing unit 202 initiates the application to be updated and scans the image with the help of the camera 203. The processing unit 202 decodes the scanned image to extract the information. The information is then used to update the application on the mobile device by updating the configuration file of the application.

In one embodiment, the configuration file information in the image is encrypted. Once the information is decoded from the image after scanning, the encrypted information is decrypted by the processing unit 202. The decrypted information is then used to update the application.

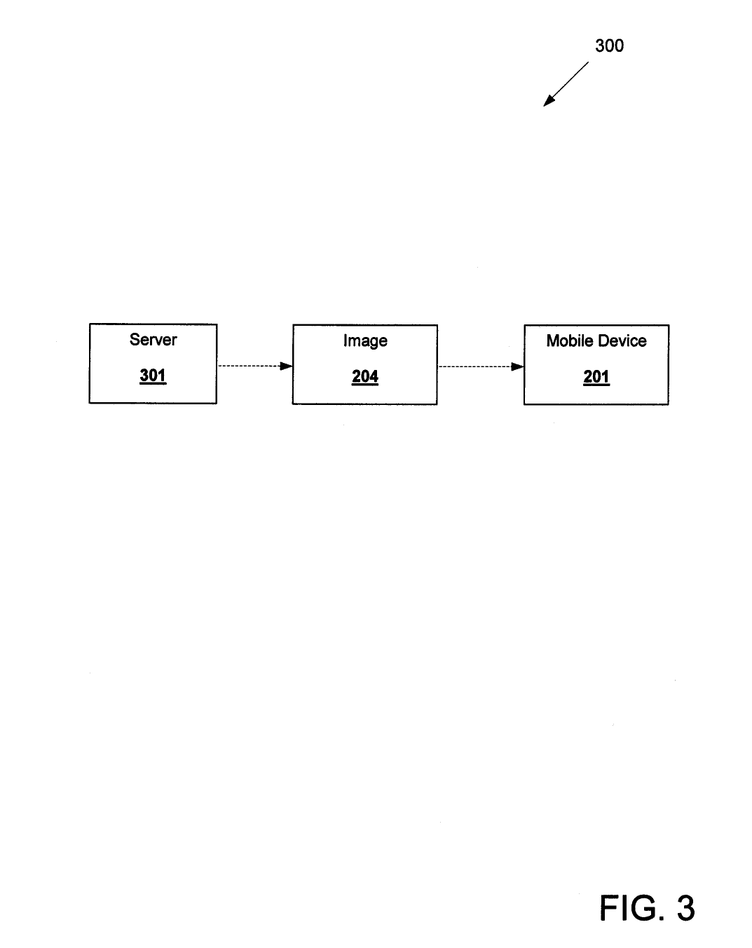

FIG. 3 shows a server 301 capable of producing an image 204 which carries encoded configuration file information required to update an application on the mobile device 201. The image is made available on any digital device or print media that is capable of displaying the image. A mobile device 201 then scans the image 204 by running the application for which the updates are available on the image 204. The application then scans the image 204 and decodes the configuration file information. The application then updates its configuration file with the information.

In one embodiment the image 204 is encoded with encrypted configuration file information. The mobile device 201 after scanning and decoding the encrypted configuration information, it decrypts the configuration file information to update the application.

### ADVANTAGES

Application update doesn't require complete application to be updated. Only the configuration/data files are required to be changed.

No dependency on network communication links like SMS, WAP/GPRS, Internet, Bluetooth, USSD, etc.

Essentially negligible processing time and thus proves to be real time.

Cuts down on communication and infrastructure costs. Hence, proves to be cost effective.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for updating an application on a mobile device comprising acts of initiating the application to be updated on the mobile device;
scanning an encoded image of a predetermined pattern from a source using the mobile device;
decoding the scanned image for extracting information required to update the application; and
updating the application on the mobile device based on the extracted information.

2. The method as claimed in claim 1, wherein the image is scanned using a camera of the mobile device.

3. The method as claimed in claim 1, wherein the image is selected from at least one of barcode image and quick response code image.

4. The method as claimed in claim 1, wherein the information comprises changes to be made to a configuration file of the application.

5. The method as claimed in claim 1, wherein the source is selected from at least one of digital device and print media that are capable of displaying the image.

6. The method as claimed in claim 1, wherein the information is encrypted.

7. The method as claimed in claim 6, wherein the encrypted information is decrypted after decoding the scanned image.

8. A mobile device comprising:
a camera capable of scanning an encoded image having information required to updated an application on the mobile device; and
a processing unit capable of performing acts of:
initiating the application on the mobile device;
decoding the scanned image to extract the information; and
updating the application on the mobile device based on the extracted information.

9. The mobile device as claimed in claim 8, wherein the information is encrypted.

10. The mobile device as claimed in claim 9, wherein the encrypted information is decrypted after decoding the scanned image.

11. A system for updating an application on a mobile device comprising:
a server to generate an image of predetermined pattern encoded with an information required to update the application; and
a mobile device to scan the generated image, to decode the information from the scanned image and to update the application using the decoded information.

12. The system as claimed in claim 11, wherein the image is selected from at least one of barcode image and quick response code image.

13. The system as claimed in claim 11, wherein the mobile device is selected from at least one of mobile phone, Personal Digital Assistant, laptop, tablet pc and other mobile device capable of reading the image.

14. The system as claimed in claim 11, wherein the information is encrypted.

15. The system as claimed in claim 14, wherein the encrypted information is decrypted after decoding the scanned image.
